(19) United States
(12) Patent Application Publication
(10) Pub. No.: US 2022/0261578 A1
(43) Pub. Date: Aug. 18, 2022

(54) Method, System and Apparatus for Dynamic Inventory Guidance and Mapping

(71) Applicant: ZEBRA TECHNOLOGIES CORPORATION, Lincolnshire, IL (US)

(72) Inventors: Patrenahalli M. Narendra, Hoffman Estates, IL (US); Charles Bolen, Kings Park, NY (US)

(21) Appl. No.: 17/174,987

(22) Filed: Feb. 12, 2021

(51) Int. Cl. G06K 9/00; G06T 7/73; G06T 7/50

(52) U.S. Cl. CPC G06K 9/00671; G06T 2207/10028; G06T 7/50; G06T 7/74

(57) ABSTRACT

A mobile device includes: a camera; a display; a tracking sensor; and a controller connected to a repository of item identifiers and item positions in a facility frame of reference for items disposed on support surfaces within a facility, the controller configured to: track, via the tracking sensor, successive poses of the mobile device in the facility frame of reference; control the camera to capture a stream of images while tracking the poses, and for each image: determine, based on the tracked poses, whether to perform item detection, and when the determination is affirmative, (i) process the image to detect respective indicia affixed to a subset of the items and decode respective item identifiers from the indicia, (ii) generate positions of the detected indicia in the facility frame of reference, based on the poses of the mobile device, and (iii) update the repository with the decoded item identifiers and the generated positions.

### BACKGROUND

Environments such as retail facilities typically include stock rooms or the like, in which items are stored temporarily prior to being moved to shelves, racks and the like in a front portion of the facility accessible to customers. While the front of the facility may have a planned layout specifying locations for each type of item, the stock room may not have a planned layout. Instead, items may simply be placed on any available shelving space in the stock room upon receipt (e.g. at a receiving bay). Locating items in the stock room, e.g. to restock shelves in the front of the facility, may therefore be time-consuming and costly for staff of the facility.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for inventory guidance and mapping.

FIG. 2 is a block diagram of certain internal hardware components of the mobile computing device of FIG. 1.

FIG. 3 is a flowchart of a method of inventory guidance and mapping.

FIG. 4 is a diagram illustrating pose tracking by the mobile device of FIGS. 1 and 2.

FIG. 5 is a diagram illustrating an image captured at block 310 of the method of FIG. 3.

FIG. 6 is a diagram illustrating an example performance of block 315 of the method of FIG. 3.

FIG. 7 is a diagram illustrating a further example performance of block 315 of the method of FIG. 3.

FIG. 8 is a diagram illustrating a further example performance of block 315 of the method of FIG. 3.

FIG. 9 is a flowchart of a method of maintaining the repository of FIG. 1.

FIG. 10 is a diagram of another example system for inventory guidance and mapping.

FIG. 11 is a diagram of a system for inventory guidance and mapping illustrating a further example mobile computing device with distinct image sensors.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a mobile device including: a camera; a display; a tracking sensor; and a controller connected to a repository of item identifiers and item positions in a facility frame of reference for items disposed on support surfaces within a facility, the controller configured to: track, via the tracking sensor, successive poses of the mobile device in the facility frame of reference; control the camera to capture a stream of images while tracking the poses, and for each image: determine, based on the tracked poses, whether to perform item detection, and when the determination is affirmative, (i) process the image to detect respective indicia affixed to a subset of the items and decode respective item identifiers from the indicia, (ii) generate positions of the detected indicia in the facility frame of reference, based on the poses of the mobile device, and (iii) update the repository with the decoded item identifiers and the generated positions.

Additional examples disclosed herein are directed to a method in a mobile computing device deployed in a facility containing items disposed on support surfaces, the method comprising: tracking, via a tracking sensor, successive poses of the mobile device in a facility frame of reference; controlling a camera to capture a stream of images while tracking the poses, and for each image: determining, based on the tracked poses, whether to perform item detection, and when the determination is affirmative, (i) processing the image to detect indicia affixed to a subset of the items and decode item identifiers from the indicia, (ii) generating positions of the detected indicia in the facility frame of reference, based on the poses of the mobile device, and (iii) updating a repository with the decoded item identifiers and the generated positions.

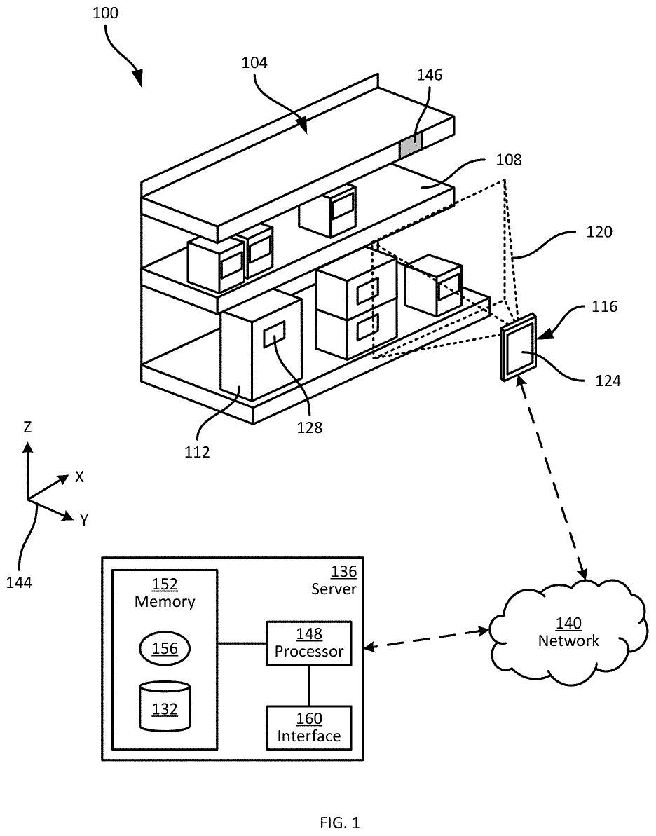

FIG. 1 illustrates a system 100 for dynamic inventory guidance and mapping. The system 100 can be deployed in an environment such as a retail facility. In particular, in this example the system 100 is deployed in a stock room of such a facility, in which items are stored prior to placement in a customer-accessible portion of the facility that may be referred to as the front of the facility. The stock room may therefore also be referred to as the back room, and is generally accessible only to staff at the facility.

Items received at the facility, e.g. via a receiving bay or the like, are generally placed on support structures such as shelves in the stock room, until restocking of the relevant items is required in the front of the facility. At that point, facility staff can be tasked with retrieving the items requiring restocking from the back room, and transporting those items to the appropriate locations in the front of the facility.

Locations for items in the front of the facility are typically predetermined, e.g. according to a planogram that specifies, for each portion of shelving or other support structures, which items are to be placed on such structures. Traveling to the appropriate location in the front of the facility to restock an item is therefore straightforward for a worker, as the planogram can be accessed from a mobile device operated by the worker, kept on a printed sheet or the like. Locating the item in the back room before transporting the item to the front of the facility, however, may be a greater challenge. A planogram may not be defined for the back room. Instead, as items are received for storage in the back room, the items may be placed on any available shelving, and the location of such items may therefore not be recorded. Further, the location of items in the back room may change frequently over time. Also, individual items may be placed in a larger carton or box with no markings to identify them in the crowded shelf when placed one on top of the other. As a result, locating an item to be restocked from the back room may be time-consuming and therefore costly to the facility.

The system 100 enables the provision of directional guidance to staff for items in the back room, despite the lack of a predefined planogram specifying locations for the items stored in the back room. Further, in some examples the system 100 enables the generation of a map of the back room, filling the role of a planogram and enhancing the level of directional guidance that can be provided to staff.

As shown in FIG. 1, the back room mentioned above includes at least one support structure such as a shelf module 104 with one or more support surfaces 108 carrying items 112. As shown in FIG. 1, the items 112 may be of different types. Each type of item may be identified by an item identifier such as a product code (e.g. a universal product code or UPC) or the like. Further, the items 112 are placed on the support structure 104 in arbitrary locations, e.g. based on which portions of the support surfaces 108 were free at the time of receipt of each item 112. Thus, items 112 of the same type are not necessarily grouped together in the back room, and the location of items 112 of a given type within the back room may vary over time with greater frequency than the location of such items 112 varies in the front of the facility.

In order to facilitate the retrieval of the items 112, the system 100 also includes a mobile computing device 116, such as a smart phone, a tablet computer, or the like. The device 116 is operated by a staff member at the facility, and includes a camera with a field of view (FOV) 120, as well as a display 124. The device 116 can be manipulated to place at least a portion of the support structure 104 within the FOV, and the device 116 can be configured to capture a stream of images. From such images, the device 116 can detect and decode respective indicia 128 affixed to each item 112. The indicia 128 can include one- or two-dimensional barcodes or other fiducial markers. In the present example, the indicia are fiducial markers designed for visibility at distances exceeding about two meters (e.g. large 2D codes such as DataMatrix, QR and also fiducial markers designed for long range acquisition such as AprilTag and ArUco tags), enabling the device 116 to capture images from greater distances from the support structure 104 in order to capture a larger number of items 112 in each image. More generally, the indicia 128 may be implemented as any readily detectable feature of an item, such as a logo, shape or the like.

From the captured images, the device 116 can be configured to detect and decode the indicia 128, and to present the images on the display 124, with overlays highlighting a particular item sought for restocking, for example. As will be apparent to those skilled in the art, however, the reliability of detection and decoding of indicia may be negatively affected by device motion. As a result, when the device 116 is oriented to capture portions of the support structure 104 as the operator of the device 116 traverses the support structure 104, many captured images may include motion blur or other artifacts preventing detection and decoding of the indicia 128.

The device 116 therefore implements additional functionality, described below in greater detail, to evaluate current movement of the device 116 and determine whether to attempt to detect and decode indicia. For at least some of the images in the above-mentioned stream, the determination may be negative, with the result that no decoding is attempted. To maintain a consistent rendering of information on the display 124, the device 116 does not base such rendering directly on the results of decoding the currently-displayed image. Instead, the device 116 is configured to associate three-dimensional positions with each detected and decoded indicium 128, and to update a repository 132 with such positions. That is, although the arrangement of the items 112 in the back room is not planned in advance, the current arrangement can be discovered and stored for later use by the device 116 (and any other devices with the capabilities described herein deployed in the facility). In the present example, the repository 132 is maintained by a server 136 connected with the device 116 via a network 140. In other examples, the repository 132 may be maintained locally by the device 116.

The positions of the indicia 128 are determined according to a frame of reference 144 previously defined in the facility. More specifically, the device 116 is configured to track its own pose (i.e. location and orientation) relative to the frame of reference 144. Knowledge of a current pose of the device 116 enables the generation of a position in the frame of reference 144 for an indicium 128 detected at the current device pose. To facilitate tracking of the pose of the device 116, the support structure 104 itself can include an indicium 146 affixed thereto, having previously established coordinates within the frame of reference 144. The indicium 146 can, in other words, be employed as an anchor enabling the device 116 to initialize and/or correct its current pose relative to the frame of reference 144. Such fixed indicia may be deployed throughout the facility, and may be supplemented or replaced by other anchors, such as wireless beacons, and the like.

Certain internal components of the server 136 are also illustrated in FIG. 1. In particular, the server 136 includes a processor 148 (e.g. one or more central processing units), interconnected with a non-transitory computer readable storage medium, such as a memory 152. The memory 152 includes a combination of volatile memory (e.g. Random Access Memory or RAM) and non-volatile memory (e.g. read only memory or ROM, Electrically Erasable Programmable Read Only Memory or EEPROM, flash memory). The processor 148 and the memory 152 each comprise one or more integrated circuits.

The memory 152 stores computer readable instructions for execution by the processor 148. In particular, the memory 152 stores an inventory tracking and guidance application 156 (also referred to simply as the application 156) which, when executed by the processor 148, configures the processor 148 to perform various functions discussed below in greater detail and related to the receipt of indicia positions from the device 116 (and other similar devices deployed in the facility in some examples) and the maintenance of the repository 132 based on such received information. The application 156 may also be implemented as a suite of distinct applications in other examples. Those skilled in the art will appreciate that the functionality implemented by the processor 148 via the execution of the application 156 may also be implemented by one or more specially designed hardware and firmware components, such as field-programmable gate arrays (FPGAs), application-specific integrated circuits (ASICs) and the like in other embodiments.

The server 136 also includes a communications interface 160 enabling the server 136 to communicate with other computing devices, including the device 116, via the network 140. The communications interface 160 includes suitable hardware elements (e.g. transceivers, ports and the like) and corresponding firmware according to the communications technology employed by the network 140.

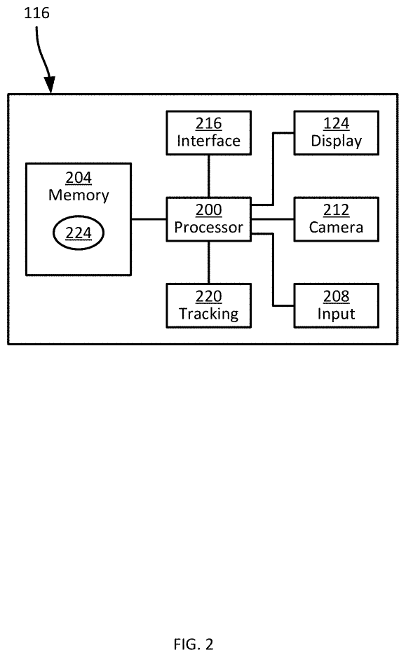

Turning to FIG. 2, prior to discussing the functionality of the system 100 in greater detail, certain internal components of the device 116 are shown. The device 116 includes a processor 200 (e.g. one or more central processing units), interconnected with a non-transitory computer readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 each comprise one or more integrated circuits.

The device 116 also includes at least one input device 208 interconnected with the processor 200. The input device 208 is configured to receive input (e.g. from an operator of the device 116) and provide data representative of the received input to the processor 200. The input device 208 includes any one of, or a suitable combination of, a touch screen integrated with the display 124, a keypad, a microphone, and the like.

The device 116 also includes a camera 212 including a suitable image sensor or combination of image sensors. The camera 212 is configured to capture a sequence of images (e.g. a video stream) for provision to the processor 200 and subsequent processing to detect and decode the indicia 128, and in some examples to assist in tracking the pose of the device 116 in the frame of reference 144.

In addition to the display 124, the device 116 can also include one or more other output devices, such as a speaker, a notification LED, and the like (not shown). The device 116 also includes a communications interface 216 enabling the device 116 to communicate with other computing devices, such as the server 136, via the network 140. The interface 216 therefore includes a suitable combination of hardware elements (e.g. transceivers, antenna elements and the like) and accompanying firmware to enable such communication.

Further, the device 116 includes a tracking sensor 220 for use in tracking the pose of the device 116. The tracking sensor 220 can include a motion sensor such as an inertial measurement unit (IMU) including one or more accelerometers, one or more gyroscopes, and/or one or more magnetometers. The tracking sensor 220 can also include a depth sensor, such as a depth camera, a lidar sensor, or the like. Data collected by the tracking sensor 220 is processed, in some examples along with images from the camera 212, to determine a current pose of the device 116.

The memory 204 stores computer readable instructions for execution by the processor 200. In particular, the memory 204 stores a inventory tracking application 224 (also referred to simply as the application 224) which, when executed by the processor 200, configures the processor 200 to perform various functions discussed below in greater detail and related to the tracking of the pose of the device 116 and the generation of three-dimensional positions for the indicia 128. The application 224 may also be implemented as a suite of distinct applications in other examples. Those skilled in the art will appreciate that the functionality implemented by the processor 200 via the execution of the application 224 may also be implemented by one or more specially designed hardware and firmware components, such as FPGAs, ASICs and the like in other embodiments. As noted above, in some examples the memory 204 can also store the repository 132, rather than the repository 132 being stored at the server 136.

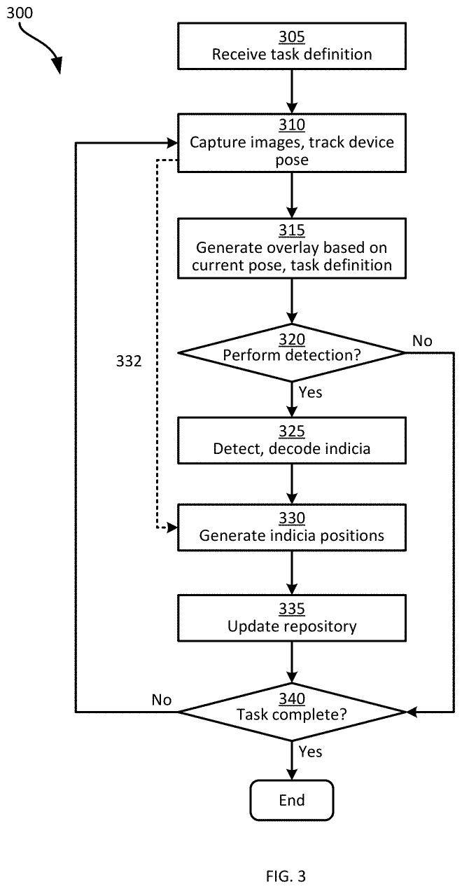

Turning to FIG. 3, the functionality of the system 100 will be described in further detail, with reference to a method 300 of dynamic inventory guidance and mapping. The method 300 will be described in conjunction with its performance by the device 116. However, in some examples, certain blocks of the method 300 can be performed by the server 136 rather than the device 116.

The method 300 is performed, in the illustrated example, in the context of an operator of the device 116 (e.g. a staff member at the facility) seeking a given item 112 in the back room of the facility. At block 305, the device 116 is configured to receive a task definition, e.g. from the server 136. The task definition includes at least an item identifier of the relevant item. The item identifier, in this example, is the identifier encoded by the corresponding indicium 128 affixed to that item 112. The task definition may also specify a quantity of the relevant item 112 to be retrieved. In some examples, the task definition can include identifiers and quantities for more than one item. The task definition may also, depending on the state of the repository 132, include a map of the back room (e.g. an overhead view of the back room) indicating the last known position of the item(s) in the task definition. In this example performance of the method 300, the repository 132 is assumed to be empty (that is, no known locations of items 112 in the back room are recorded), and the map is therefore omitted from the task definition.

At block 310, the device 116 is configured to begin capturing a stream of images via the camera 212. The device 116 also begins tracking successive poses (i.e. positions and orientations of the device 116 in three dimensions), at any suitable frequency (e.g. at a frequency of about 30 or 60 Hz, although a wide variety of other pose estimation frequencies can also be employed). The frequency with which pose estimates are generated by the device 116 may depend, for example, on the sampling frequency of the tracking sensor 220, the frame rate of the camera 212, available computational resources of the device 116, and the like.

To track the pose of the device 116, the processor 200 controls the tracking sensor 220 to capture data representing the surroundings of the device 116, as well as motion of the device 116. In the present example, the images captured by the camera 212 are also employed for pose tracking, as those images represent a portion of the surroundings of the device 116. The images may be combined with point clouds from a depth sensor, and/or motion data defining accelerations affecting the device 116, and changes in orientation of the device 116. The processor 200 detects one or more image features in the images from the camera 212 and/or depth data when the tracking sensor 220 includes a depth sensor. The device 116 then tracks the changes in position of such features between successive images. Examples of features include corners, edges (e.g. changes in gradient) and the like detectable via any suitable feature-detection algorithms. The movement of such features between images and/or point clouds, along with motion data such as acceleration and orientation change, is indicative of movement of the device 104.

The positions of the above-mentioned features, as well as motion data from an IMU of the tracking sensor 220, can be provided as inputs to a pose estimator implemented by the processor 200, such as a Kalman filter. Various mechanisms will occur to those skilled in the art to combine image and/or motion sensor data to generate pose estimations. Examples of such mechanisms include those implemented by the ARCore software development kit provided by Google LLC, and the ARKit software development kit provided by Apple Inc.

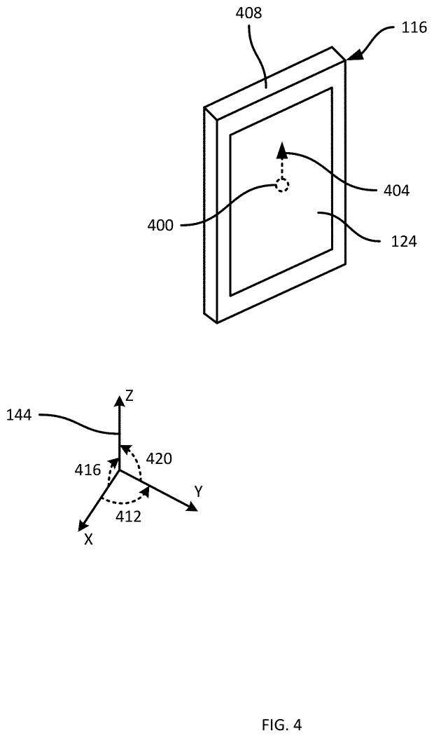

Turning to FIG. 4, an example pose estimate is illustrated as determined at block 310, including a location 400 and an orientation 404. The location 400 represents the location of a centroid of the device 116, but in other embodiments, the location 400 can correspond to a different point of the device 116. The orientation 404 represents the direction in which a forward surface 408 of the device 116 is currently facing. The location 400 and orientation 404 are defined relative to the frame of reference 144 as noted above. In particular, the location 400 is defined by positions along each of the three axes of the frame of reference 144, and the orientation 404 is defined by angles in each of three planes (e.g. an angle 412 in the XY plane, an angle 416 the XZ plane, and an angle 420 in the ZY plane). Pose tracking at block 310, once initiated, is performed continuously throughout the remainder of the method 300.

Once pose tracking and image capture have been initiated, each of the remaining blocks of the method 300 are performed for each captured image and accompanying pose estimate. That is, in this example, images and pose estimates are assumed to be generated substantially simultaneously, and blocks 315-340 are repeated for each image capture/pose estimate.

At block 315, the device 116 is configured to generate an overlay to present on the display 124, along with the current image captured via block 310. The generation and presentation of the overlay enables the device 116 to provide augmented reality functionality, by presenting the images from the camera 212 substantially in real time, along with additional information sourced from the repository 132. The overlay may, for example, highlight the position(s) of the item(s) identified in the task definition from block 305, when such items 112 are within the FOV 120. As noted above, the repository 132 is assumed not to contain any positions in connection with item identifiers yet. In the present performance of block 315, the overlay may contain no information and can simply be omitted. The generation of overlays will be discussed in connection with subsequent performances of block 315 below.

At block 320, the device 116 is configured to determine whether to perform item detection processing of the image. Item detection processing includes detecting and decoding indicia 128 visible in the image, to obtain the item identifiers encoded therein. Further, detecting the locations of the indicia 128 in the image enables the device 116 to determine the positions of the indicia 128 in the frame of reference 144. However, as noted earlier, movement of the device 116 may render detection and decoding of the indicia 128 difficult, e.g. by rendering some indicia 128 undetectable due to motion blur or the like. The device 116 therefore does not commit computational resources to detecting and decoding indicia unless the current rate of motion of the device 116 is low enough to be unlikely to negatively affect detection and decoding performance.

Specifically, at block 320 the device 116 is configured to determine a rate of motion from the current pose and at least one preceding pose in the sequence initiated at block 310. For example, the rate of motion may be determined by comparing the previous pose and the current pose. Each pose is timestamped, and the difference between the poses, as well as the difference between the corresponding timestamps, defines a rate of motion. The rate determined at block 320 can include a rate of change in any or all of the angles 412, 416, and 420 shown in FIG. 4, and/or a velocity (i.e. a rate of change of the location 400 shown in FIG. 4). The rate of motion is then compared to one or more thresholds (e.g. a first threshold for angular motion, and a second threshold for linear motion or velocity). When the rate(s) of motion exceed any of the thresholds, the determination at block 320 is negative, and the device 116 bypasses detection and decoding functions.

An affirmative determination at block 320 indicates that the device 116 is sufficiently close to being stationary that detection and decoding of the indicia is likely to succeed. The device 116 therefore proceeds to block 325.

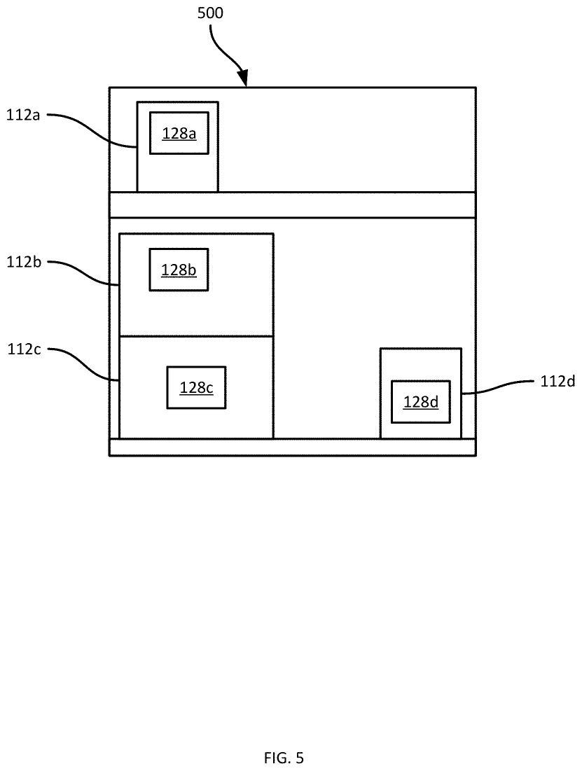

At block 325, the device 116 processes the image to detect and decode any indicia that are within the FOV 120 (i.e. that were captured in the image). In other words, the indicia 128 detected and decoded at block 325 correspond to a subset of the items in the back room. Detection and decoding can be performed by applying any of a variety of suitable detection and decoding mechanisms to the image. Turning to FIG. 5, an example image 500 is shown as captured by the device 116 with a portion of the support structure 104 within the FOV 120. At block 325, the device 116 is configured to detect the indicia 128a, 128b, 128c, and 128d affixed to respective items 112a, 112b, 112c, and 112d. The indicia 128 detected are also decoded to obtain item identifiers, or unique per-indicium identifiers, depending on the format of indicia employed. In some examples, the information density of the indicia 128 may be too low to uniquely identify each individual indicium 128 in the facility, and therefore indicia 128 affixed to different instances of the same item type may have the same identifier encoded therein.

At block 330, having detected and decoded the indicia 128, the device 116 is configured to generate positions, in the frame of reference 144, of each indicium 128. For example, a two-dimensional bounding box (more generally a polygon whose corner coordinates are determined in the image) corresponding to a detected indicium in the image may be projected, based on known operational parameters of the camera 212 (e.g. focal length, position relative to the centroid of the device 116, and the like) onto a plane or other point cloud feature detected during the pose tracking initiated at block 310. Various back-projection techniques from image coordinates to three-dimensional coordinates will occur to those skilled in the art for use at block 330. For example, knowledge of the pose of the device 116 in the frame of reference 144, and of the position of features such as a plane defined by the items and the support structure 104 relative to the device 116 (via pose tracking), enables the projection of one or more rays from image coordinates onto the three-dimensional features mentioned above to determine the position of the detected indicium in the frame of reference 144. The position of each detected indicium may be represented, for example, by a bounding box defined by four sets of 3D coordinates. In other examples, the position of a detected indicium may be represented by a single set of 3D coordinates, corresponding to the center of the indicium 128, as well as a normal vector of a plane on which the indicium lies (e.g. a plane formed by the forward surfaces of the items 112 and shelf edges of the support structure 104).

As will now be apparent to those skilled in the art, there may be a delay between the capture of the image and pose at block 310, and the detection and decoding of indicia 128 at block 325, that is sufficiently long (e.g. between about 50 ms and about 100 ms, in some examples) for the pose of the device 116 to have changed. To avoid incorrectly positioning the detected indicia 128, the device 116 is configured to associate each capture image and pose with a timestamp indicating when the relevant image and pose were captured. Further, the device 116 is configured to associate any results of the decoding process at block 325 with the same timestamp, such that when the decoding operation is complete (by which time more recently images and poses may be available), the device pose captured at the same time as the image from which the decode results were obtained is employed to generate the positions of the indicia 128. Use of historical pose data to determine the positions of detected indicia is indicated in FIG. 3 by a link 332 from block 310 to block 330.

At block 335, the device 116 is configured to update the repository 132 with the item identifiers decoded at block 325, and the corresponding positions generated at block 330. In the present example, at block 335 the device 116 sends the output of blocks 325 and 330 to the server 136 for storage in the repository 132. Such information is conveyed to the server 136 along with a timestamp indicating when the indicia 128 were detected and decoded. In other examples, where the repository 132 is maintained locally in the memory 204, transmission to the server 136 may be omitted.

The host of the repository 132 (either the server 136 or the device 116) may perform additional functionality upon receipt of the above data, as will be discussed further below. In general, however, after block 335 the repository 132 contains at least the above-mentioned item identifiers and positions. In other words, despite the lack of a planned layout for the back room of the facility, the repository 132 contains partial layout information, dynamically collected by the device 116 while the operator of the device 116 searches for a particular item (e.g. as specified in the task definition from block 305).

At block 340, the device 116 can determine whether the task from block 305 is complete. Determination of whether the task is complete can include determining whether the image contains an indicium corresponding to the item in the task definition. When the determination is affirmative, indicating that the corresponding item is within the FOV 120 of the camera 212, the method 300 may end. Otherwise, the device 116 continues pose tracking and image capture at block 310. In the present example, it is assumed that the determination at block 340 is negative, and the device 116 therefore returns to block 310.

Upon capturing the next image and pose at block 310, in a further performance of block 315, the device 116 generates an overlay for presentation on the display 124. As noted above, the overlay is generated not based on detection and decoding of indicia in the frame currently being processed, but on the repository 132. Generating overlays based on data from the repository 132 enables overlays to be generated consistently (that is, for every image frame captured by the device 116 and presented on the display 124), whether or not the current conditions are favorable for detection and decoding of the indicia 128.

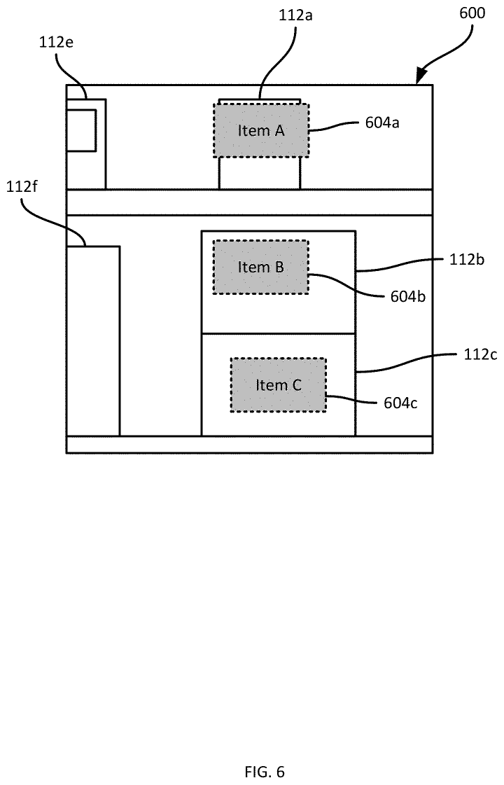

In this example, the repository 132 now contains four detected indicia, as discussed above in connection with FIG. 5. FIG. 6 illustrates a further image 600 captured at block 310, in which the device 116 has moved along the front of the support structure 104. The items 112a, 112b, and 112c remain visible, but the item 112d is no longer visible. Meanwhile, portions of additional items 112e and 112f are visible in the image 600.

The overlay generated at block 315 can include item indicators bearing information such as an item identifier, and may also include other information from the repository 132, such as the timestamp corresponding to the most recent detection of the indicated item 112 at this position, a confidence level (discussed below) associated with the item indicator, and the like. The item indicator may be presented on the display 124 at a position corresponding to the position of the indicium 128. Thus, as shown in FIG. 6, item indicators 604a, 604b, and 604c are overlaid on the indicia 128a, 128b, and 128c respectively. Of particular note, the item indicators 604 are provided as an overlay on the display 124 regardless of whether the motion of the device 116 currently permits detection and decoding of the indicia 128, as a result of the previous storage of 3D positions of the indicia 128 in the repository 132.

At block 320, the device 116 is configured to determine whether to perform indicium detection and decoding. In the present example, it is assumed that the movement of the device 116 is sufficient to exceed the threshold(s) applied at block 320, and the determination is therefore negative. Indicium detection and decoding are therefore bypassed, and the device 116 proceeds directly to block 340. Given that no additional items are sufficiently visible to identify in the image 600 than in the image 500, the determination at block 340 is negative, and the device 116 returns again to block 310.

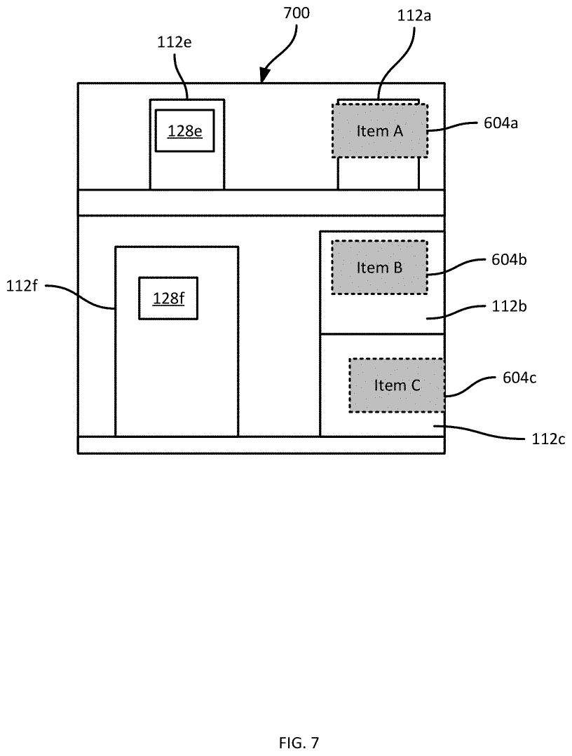

Referring to FIG. 7, a further image 700 is shown following further movement of the device 116 along the support structure 104 such that items 112e and 112f fall within the FOV 120. The overlay generated at block 315 includes the item indicators 604a, 604b, and 604c, but does not include overlay elements for the items 112e and 112f because the corresponding indicia 128e and 128f have not yet been detected and positioned. Assuming that the determination at block 320 is affirmative, at block 325 the indicia 128e and 128f are detected, and at block 330 positions in the frame of reference 144 are generated for the indicia 128e and 128f As will now be apparent, some or all of the indicia 128a, 128b, and 128c can also be detected and decoded at block 325, in which case updated positions for the indicia 128a, 128b, and 128c are generated at block 330. The data from blocks 325 and 330 is then used to update the repository 132 at block 335, as described above.

The determination at block 340 is then performed. In the present example, it is assumed that the item 112f is identified in the task definition from block 305. However, because the detection and decoding of the indicium 128f is delayed until after capture and display of the next frame, the determination at block 340 is negative while the image 700 is displayed, because decoding is not yet complete.

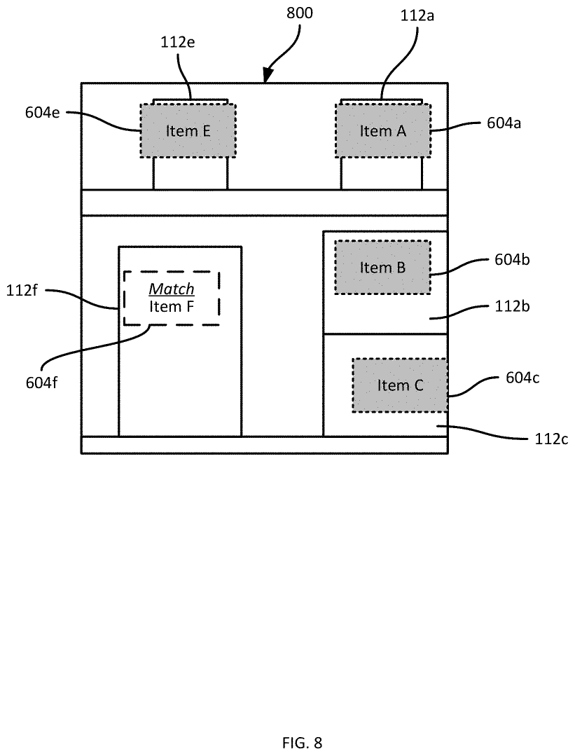

The above process is then repeated once more. FIG. 8 illustrates a further image 800 captured at the same device position as the image 700, following detection and decoding of the indicia 128e and 128f (and storage of the output of blocks 325 and 330 in the repository 132). In particular, the image 800 is presented on the display 124 with an overlay including the item indicators 604a, 604b, and 604c mentioned above, as well as item indicators 604e and 604f resulting from the previous detection and decoding of the indicia 128e and 128f. The item indicator 604f, in particular, is distinguished from the other item indicators 604, because it corresponds to the item identified in the task definition from block 305. For example, the item indicator 604f may have a different color or pattern, and may include additional information indicating that the corresponding item 112 is the item sought by the operator of the device 116. The determination at block 340 is then affirmative, and performance of the method 300 can end.

Through repeated performances of the method 300, therefore, the repository 132 is populated with detected positions of the items 112. The repository 132 therefore stores at least a partial map, collected in an ad-hoc manner by one or more devices 116, of the back room of the facility. The repository 132 may therefore be used to provide guidance to staff in the back room, e.g. in the form of the map mentioned above in connection with the task definition at block 305.

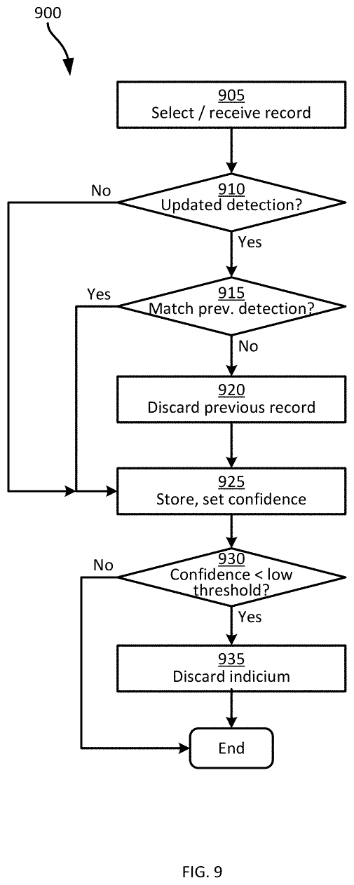

As will now be apparent to those skilled in the art, the unplanned nature of the facility back room means that over time, items 112 are likely to be removed from the support structure 104 and replaced with different items (i.e. with items bearing indicia 128 that do not match the information in the repository 132). The server 136 is therefore configured to perform certain functionality to maintain the repository 132, as discussed below in connection with FIG. 9.

FIG. 9 illustrates a method 900 of maintaining the repository 132. The method 900 is discussed below as being performed by the server 136, but may also be performed by the device 116 in examples in which the device 116 hosts the repository 132. In general, the method 900 enables the server 136 to insert new information in the repository 132, and discard outdated information from the repository 132. Further, via the method 900 the server 136 can indicate confidence levels in contents of the repository 132 that are not confirmed to be outdated by more recent detections, but whose reliability may nevertheless be in question, e.g. due to age.

At block 905, the server 136 is configured to select a record in the repository 132, or receive a record from the device 116, as a result of the transmission at block 335 mentioned earlier. In other words, transmission of data from the device 116 at block 335 can initiate performance of the method 900. In other examples, the method 900 can be automatically initiated periodically, in the absence of new data from the device 116. Each record in the repository 132 contains a particular item detection. That is, the record contains an item identifier decoded from an indicium, as well as a position of that indicium in the frame of reference 144. As noted earlier, the record also includes a timestamp indicating when the indicium was detected and located.

Responsive to selecting or receiving the record, at block 910 the server 136 determines whether the data selected or received at block 905 constitutes an updated item detection corresponding to a previous record in the repository 132. For example, when a detection of an indicium by the device 116 is received at the server 136 at block 905, at block 910 the server 136 can be configured to retrieve any record in the database with a position within a threshold distance of the detected position from the device 116, since that record likely corresponds to the same physical space on the support structure 104. When no such record is found, the server 136 may bypass blocks 915 and 920, and proceed directly to block 925, discussed below.

When the determination at block 910 is affirmative, indicating that the received data from the device 116 is for a position already defined in the repository 132, the server 136 proceeds to block 915. At block 915, the server 136 determines whether the detected item identifier from block 905 matches the previously stored item identifier for the matching position. When the determination at block 915 is affirmative, the detection received at block 905 is therefore assumed to be a more recent detection of the same item 112 (or at least an item 112 of the same type), and the server 136 proceeds to block 925.

When the determination at block 915 is negative, the server 136 is configured to discard the previous record at block 920, because the receipt of a new item detection at block 905 indicates that the item 112 previously associated with that position is no longer present.

At block 925, the server 135 is configured to store the record from block 905, and to set a confidence level for the stored record. The confidence level indicates, according to any suitable scale (e.g. in percentages, from 0% indicating no confidence, to 100% indicating absolute confidence), how likely the record is to reflect reality. Responsive to receiving a new item detection at block 905, the server 136 may be configured to set a maximum confidence level (e.g. 100%) at block 925, because the detection was made very recently. When the record selected at block 905 is not a newly received record, but an existing record, at block 925 the server 136 is configured to update the previous confidence level of the record based on the age of the record. For example, confidence levels can be scaled linearly with age between an age of zero and an upper age limit (e.g. one week), such that a newly received detection has a confidence level of 100%, while a one-week old detection has a confidence level of 0%. Various other confidence scaling mechanisms may also occur to those skilled in the art.

At block 930, the server 136 can determine whether the confidence level of the record (as set or updated at block 925) falls below a lower threshold (e.g. 20%). When the determination at block 925 is affirmative, the record may simply be discarded at block 935.

The confidence levels mentioned above may be employed by either or both of the server 136 and the device 116. For example, when generating a task definition for transmission to the device 116, the server may include a map showing the last known position of the relevant item 112 only when the confidence level associated with that position exceeds a threshold (e.g. 50%, although a wide variety of other levels may also be selected).

In other examples, the records of the repository 132 may be used as anchors by the device 116 in pose tracking at block 310. For example, to establish or correct the pose of the device 116, the device 116 may retrieve some or all records from the repository 132. As will now be apparent, an arrangement of indicia 128 visible within the FOV 120, each with known positions relative to the frame of reference 144, may be used by the device 116 to determine the device's own pose in the frame of reference 144. The device 116 may be configured, however, to only use such arrangements as pose tracking anchors when each indicium in the arrangement has a sufficiently high confidence level. In some examples, a single indicium 128 may be used as an anchor, again with a sufficiently elevated confidence level.

As will now be apparent to those skilled in the art, the inventory tracking and guidance mechanisms described above may also be deployed in environments other than the back room discussed above. For example, certain retail facilities employ “top stock” storage in a front portion of the facility. For example, when items are transported to the designated location in the front of the facility for shelving, but insufficient space is available on such shelving to accommodate all the items, excess items may be placed on an upper shelf referred to as a top stock area. Top stock storage, like back room storage, may not have a predetermined planogram assigned, and items placed in top stock may therefore be placed in an ad-hoc manner. The mechanisms described above may be applied to top stock in order to dynamically construct a map of otherwise unplanned top stock, and provide guidance to facility staff seeking items in top stock storage.

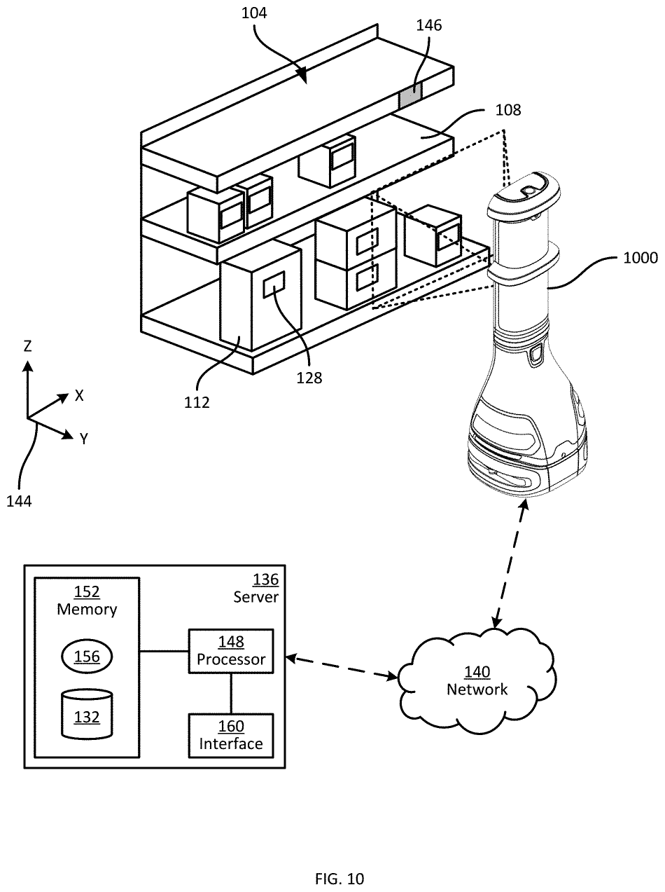

In further examples, the repository 132 may be initially and/or periodically populated by an automated, or semi-automated, apparatus, rather than by devices such as the device 116 operated by staff at the facility. For example, referring to FIG. 10, a mobile automation apparatus 1000 is shown traversing the support structure 104. The apparatus 1000 may include a set of sensors including any or all of cameras, depth sensors, and the like, as well as navigational sensors to track the pose of the apparatus 1000 relative to the frame of reference 144. The apparatus 1000 may therefore be controlled to periodically traverse the support structure 104 (and any other support structures in the facility) to capture images thereof, detect the indicia 128, and update the repository 132 with the item identifiers and corresponding positions. In other words, the apparatus 1000 may perform blocks 310, 325, 330 and 335 of the method 300. The data provided to the repository 132 by the apparatus 1000 may subsequently be used to provide guidance (e.g. the above-mentioned map) to the device 116, e.g. at block 305. Further, as discussed above, initial and/or periodic data captured by the apparatus 1000 may be updated by the device 116 and other devices operated by staff in the facility.

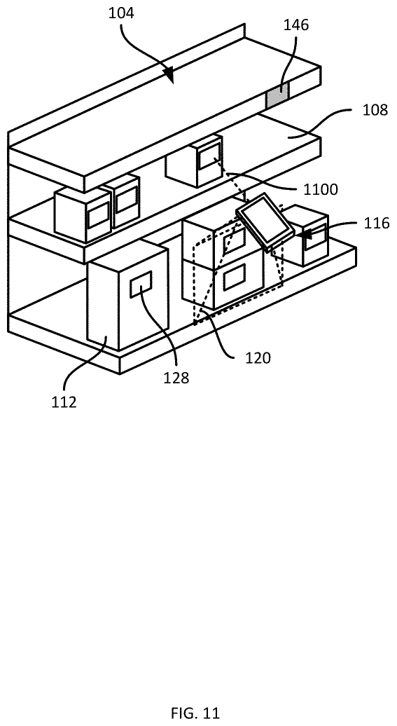

In some examples, item positions in the frame of reference 144 may be determined from the indicia 128 using a barcode scanner (e.g. a second imaging sensor) distinct from the camera 212. As shown in FIG. 11, the device 116 may include a scanner with a forward-facing field of view 1100, which in the illustrated example is not collinear with the FOV 120 of the camera 212. In such examples, one or more indicia 128 within the FOV 1100 may be detected and decoded via the scanner, while the camera 212 is employed for pose tracking as noted earlier. The device 116 can store a transform between the centroid of the device (e.g. the point on or in the device 116 at which position and orientation are defined, as mentioned in connection with FIG. 4) and the FOV 1100 of the scanner. As a result, the device 116 can determine the pose of the scanner FOV 1100 based on the pose of the device 1100 itself. In other words, the device 116 remains able to detect, decode, and generate 3D positions for barcodes or other indicia via blocks 325 and 330.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A mobile device, comprising:
a camera;
a display;
a tracking sensor; and
a controller connected to a repository of item identifiers and item positions in a facility frame of reference for items disposed on support surfaces within a facility, the controller configured to:
track, via the tracking sensor, successive poses of the mobile device in the facility frame of reference;
control the camera to capture a stream of images while tracking the poses, and for each image:
determine, based on the tracked poses, whether to perform item detection, and
when the determination is affirmative, (i) process the image to detect indicia affixed to a subset of the items and decode item identifiers from the indicia, (ii) generate positions of the detected indicia in the facility frame of reference, based on the poses of the mobile device, and (iii) update the repository with the decoded item identifiers and the generated positions.

2. The mobile device of claim 1, wherein the processor is further configured to, for each image:
based on the tracked poses, retrieve, from the repository, a visible subset of the item positions within a field of view of the camera;
generate an overlay including indicators for the visible subset of item positions; and
present, on the display, the image with the overlay.

3. The mobile device of claim 2, wherein the processor is further configured to:
receive a task definition containing one of the item identifiers;
determine whether an item position corresponding to the one of the item identifiers is in the visible subset; and
when the item position corresponding to the one of the item identifiers is in the visible subset, highlight the corresponding one of the indicators in the overlay.

4. The mobile device of claim 2, wherein the item identifiers and item positions of the repository include initial item identifiers and item positions detected by a mobile automation apparatus.

5. The mobile device of claim 1, wherein the tracking sensor includes at least one of an inertial measurement unit (IMU) and a depth sensor.

6. The mobile device of claim 1, wherein the processor is configured to determine whether to perform item detection by:
comparing device motion indicated by the tracked poses to a motion threshold; and
initiating the item detection when the device motion is below a threshold.

7. The mobile device of claim 1, wherein the processor is configured to update the repository by transmitting the decoded item identifiers and the generated positions to a server hosting the repository.

8. The mobile device of claim 1, further comprising a memory storing the repository.

9. The mobile device of claim 8, wherein the processor is further configured to:
store, with each decoded item identifier and generated position, a timestamp indicating when the decoded item identifier was most recently detected at the generated position;
assign a confidence level to the decoded item identifier; and
periodically updating the confidence level based on an age of the decoded item identifier.

10. The mobile device of claim 9, wherein the processor is configured to track the successive poses by:
retrieving at least a portion of the repository; and
selecting an anchor subset of item identifiers and associated positions, having confidence levels above a threshold.

11. The mobile device of claim 1, wherein the processor is configured to generate the positions of the detected indicia in the facility frame of reference, by:
storing timestamps in association with each tracked pose and each of the images;
responsive to detecting the indicia in the image, retrieving a tracked pose having a timestamp matching the image timestamp; and
generating the positions of the detected indicia using the retrieved tracked pose.

12. A method in a mobile computing device deployed in a facility containing items disposed on support surfaces, the method comprising:
tracking, via a tracking sensor, successive poses of the mobile device in a facility frame of reference;
controlling a camera to capture a stream of images while tracking the poses, and for each image:
determining, based on the tracked poses, whether to perform item detection, and
when the determination is affirmative, (i) processing the image to detect indicia affixed to a subset of the items and decode item identifiers from the indicia, (ii) generating positions of the detected indicia in the facility frame of reference, based on the poses of the mobile device, and (iii) updating a repository with the decoded item identifiers and the generated positions.

13. The method of claim 12, further comprising, for each image:
based on the tracked poses, retrieving, from the repository, a visible subset of the item positions within a field of view of the camera;
generating an overlay including indicators for the visible subset of item positions; and
presenting, on the display, the image with the overlay.

14. The method of claim 13, further comprising:
receiving a task definition containing one of the item identifiers;
determining whether an item position corresponding to the one of the item identifiers is in the visible subset; and
when the item position corresponding to the one of the item identifiers is in the visible subset, highlighting the corresponding one of the indicators in the overlay.

15. The method of claim 13, wherein the item identifiers and item positions of the repository include initial item identifiers and item positions detected by a mobile automation apparatus.

16. The method of claim 12, wherein the tracking sensor includes at least one of an inertial measurement unit (IMU) and a depth sensor.

17. The method of claim 12, wherein determining whether to perform item detection includes:
comparing device motion indicated by the tracked poses to a motion threshold; and
initiating the item detection when the device motion is below a threshold.

18. The method of claim 12, wherein updating the repository includes transmitting the decoded item identifiers and the generated positions to a server hosting the repository.

19. The method of claim 12, wherein updating the repository includes storing the decoded item identifiers and the generated positions in a memory of the mobile device.

20. The method of claim 19, further comprising:
storing, with each decoded item identifier and generated position, a timestamp indicating when the decoded item identifier was most recently detected at the generated position;
assigning a confidence level to the decoded item identifier; and
periodically updating the confidence level based on an age of the decoded item identifier.

21. The method of claim 20, wherein tracking the successive poses includes:
retrieving at least a portion of the repository; and
selecting an anchor subset of item identifiers and associated positions, having confidence levels above a threshold

22. The method of claim 12, wherein generating the positions of the detected indicia in the facility frame of reference includes:
storing timestamps in association with each tracked pose and each of the images;
responsive to detecting the indicia in the image, retrieving a tracked pose having a timestamp matching the image timestamp; and
generating the positions of the detected indicia using the retrieved tracked pose.
